(19) United States
(12) Patent Application Publication
(10) Pub. No.: US 2008/0247535 A1
(43) Pub. Date: Oct. 9, 2008

(54) Method and apparatus for mitigating impact of nonlinear effects on the quality of audio echo cancellation

(75) Inventors: Qin Li, Redmond, WA (US); Chao He, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/784,692

(22) Filed: Apr. 9, 2007

(51) Int. Cl. H04M 9/08

(52) U.S. Cl. 379/406.08

(57) ABSTRACT

A method is provided for reducing the adverse impact of echo on audio quality in a two-communication system. The method includes two parts. The first part begins by detecting non-linear effects (e.g. clippings and audio glitches). If a non-linear effect is detected, the system temporarily disables adaptation of the adaptive filter. In this way, filter coefficients obtained before the non-linear effect happens will not be corrupted, so the AEC can quickly recover from the non-linear effects. The second part begins by monitoring a parameter reflecting signal quality (e.g., ERLE). If the signal quality parameter falls below a given value the system switches from a full-duplex mode of operation to a half-duplex mode of operation. In this way, when a non-linear effect that is undetectable or occurs repeatedly (e.g., speaker volume changes) and which can corrupt an acoustic echo canceller (AEC) for a relatively long period of time, the system switches from full-duplex operation to half-duplex operation. In half-duplex operation, communication can only happen in one direction at a time, and thus the echo path is broken, effectively eliminating echoes. When the non-linear effect is no longer present and the quality parameter rises to a normal level, communication returns to a full-duplex mode of operation and the AEC once again removes the echoes.

### BACKGROUND

Acoustic Echo Cancellation (AEC) is a digital signal processing technology which is used to remove the acoustic echo from a speaker phone in two-way or multi-way communication systems, such as traditional telephone or modern internet audio conversation applications.

FIG. 1 illustrates an example of one end 100 of a typical two-way communication system, which includes a capture stream path and a render stream path for the audio data in the two directions. The other end is exactly the same. In the capture stream path in the figure, an analog to digital (A/D) converter 120 converts the analog sound captured by microphone 110 to digital audio samples continuously at a sampling rate (fs_{mic}). The digital audio samples are saved in capture buffer 130 sample by sample. The samples are retrieved from capture buffer in frame increments (herein denoted as “mic[n]”). Frame here means a number (n) of digital audio samples. Finally, samples in mic[n] are processed and sent to the other end.

In the render stream path, the system receives audio samples from the other end, and places them into a render buffer 140 in periodic frame increments (labeled “spk[n]” in the figure). Then the digital to analog (D/A) converter 150 reads audio samples from the render buffer sample by sample and converts them to analog signal continuously at a sampling rate, fsₛₚₖ. Finally, the analog signal is played by speaker 160.

In systems such as that depicted by FIG. 1, the near end user's voice is captured by the microphone 110 and sent to the other end. At the same time, the far end user's voice is transmitted through the network to the near end, and played through the speaker 160 or headphone. In this way, both users can hear each other and two-way communication is established. But, a problem occurs if a speaker is used instead of a headphone to play the other end's voice. For example, if the near end user uses a speaker as shown in FIG. 1, his microphone captures not only his voice but also an echo of the sound played from the speaker (labeled as “echo(t)”). In this case, the mic[n] signal that is sent to the far end user includes an echo of the far end user's voice. As the result, the far end user would hear a delayed echo of his or her voice, which is likely to cause annoyance and provide a poor user experience to that user.

Practically, the echo echo(t) can be represented by speaker signal spk(t) convolved by a linear response g(t) (assuming the room can be approximately modeled as a finite duration linear plant) as per the following equation:

$$echo ( t ) = spk ( t ) * g ( t ) = {\int }_{0}^{{T}_{e}} g ( τ ) \cdot spk ( t - τ ) d τ \qquad ( 1 )$$

where * means convolution, Tₑ is the echo length or filter length of the room response.

In order to remove the echo for the remote user, AEC 210 is added in the system as shown in FIG. 2. When a frame of samples in the mic[n] signal is retrieved from the capture buffer 130, they are sent to the AEC 210. At the same time, when a frame of samples in the spk[n] signal is sent to the render buffer 140, they are also sent to the AEC 210. The AEC 210 uses the spk[n] signal from the far end to predict the echo in the captured mic[n] signal. Then, the AEC 210 subtracts the predicted echo from the mic[n] signal. This difference or residual is the clear voice signal (voice[n]), which is theoretically echo free and very close to near end user's voice (voice(t)).

FIG. 3 depicts an implementation of the AEC 210 based on an adaptive filter 310. The AEC 210 takes two inputs, the mic[n] and spk[n] signals. It uses the spk[n] signal to predict the mic[n] signal. The prediction residual (difference of the actual mic[n] signal from the prediction based on spk[n]) is the voice[n] signal, which will be output as echo free voice and sent to the far end. In normal situations, the adaptive filter always adapts and updates its cancellation filter coefficients. However in some situations, for example when near-end voice is present, the adaptive filter needs to stop the adaptation process. Therefore the AEC 310 also includes an adaptation control input, according to which the AEC 310 selectively disables or enables adaptation of the adaptive filter.

The actual room response (that is represented as g(t) in the above convolution equation) usually varies with time, such as due to change in position of the microphone 110 or speaker 160, body movement of the near end user, and even room temperature. The room response therefore cannot be pre-determined, and must be calculated adaptively at running time. The AEC 210 commonly is based on adaptive filters such as Least Mean Square (LMS) adaptive filters 310, which can adaptively model the varying room response.

Modeling echo as a convolution of the speaker signal and room response in the manner described above is a linear process. Therefore, the AEC implementation is able to cancel the echo using adaptive filtering techniques. If there is any nonlinear effect involved during the playback or capture, then the AEC may fail. A common nonlinear effect is microphone clipping, which happens when analog gain on the capture device is too high, causing the input analog signal to be out of the range of the A/D converter. The A/D converter then clips the out of range analog input signal samples to its maximum or minimum range values. When clipping happens, the adaptive filter coefficients will be corrupted. Even after clipping has ended, the impacts are still there and AEC needs another few seconds to re-adapt to find the correct room response. Another example of a nonlinear effect that may cause the AEC to fail is audio glitches, which means there are discontinuities in the microphone capture or speaker render stream.

### SUMMARY

The following Detailed Description presents different ways to enhance AEC quality and robustness in two-way communication systems. In one way, when a non-linear effect (e.g. clipping or audio glitch) is detected, the system temporarily disables filter adaptation to prevent the filter coefficients from being corrupted. In another approach, when a non-linear effect persists or a non-linear effect is undetectable (e.g. speaker volume changes) and the AEC quality stays low for a relatively long period of time (e.g., long enough for users to perceive it is difficult to conduct a normal conversation), the system switches from full-duplex operation to half-duplex operation. In half-duplex operation, communication can only happen in one direction at any time, and thus the echo path is broken, effectively eliminating echoes. When the non-linear effect is no longer present and the AEC quality recovers, the system returns to a full-duplex mode of operation and the AEC once again effectively removes the echoes.

This Summary is provided to introduce a selection of concepts in a simplified form that is further described below in the Detailed Description. This summary is not intended to identify key features or essential features of the claimed subject matter, nor is it intended to be used as an aid in determining the scope of the claimed subject matter. Additional features and advantages of the invention will be made apparent from the following detailed description of embodiments that proceeds with reference to the accompanying drawings.

### BRIEF DESCRIPTION OF THE DRAWINGS

FIG. 1 is a block diagram illustrating one end of a typical two-way communication system.

FIG. 2 is a block diagram of the two-way communication system of FIG. 1 with audio echo cancellation.

FIG. 3 is a block diagram of an implementation of audio echo cancellation based on an adaptive filter.

FIG. 4 is a block diagram of a two-way communication system in which a non-linear effect detector is employed to detect non-linear effects and temporarily disable adaptation of the adaptive filter and a voice switching arrangement is employed to reduce the impact of nonlinear effects on the quality of audio echo cancellation.

FIG. 5 is a block diagram of a suitable computing environment for implementing a two-way communication system utilizing the AEC implementation having improved robustness and quality.

### DETAILED DESCRIPTION

The following description relates to implementations of audio echo cancellation having improved robustness and quality, and their application in two-way audio/voice communication systems (e.g., traditional or internet-based telephony, voice chat, and other two-way audio/voice communications). Although the following description illustrates the inventive audio echo cancellation in the context of an Internet-based voice telephony, it should be understood that this approach also can be applied to other two-way or multi-way audio communication systems and like applications.

Non-linear effects not only cause poor cancellation quality for the frame currently being processed, but they also cause the adaptive filter to diverge and thus the nonlinearities may affect many subsequent frames as well. As a result the AEC may take longer to recover from the nonlinearity than just the duration of nonlinearity. One approach to mitigate this problem is to stop updating the adaptive filter when non-linear effects are detected. In this way a good room response that is obtained by the AEC before the occurrence of the non-linear effect will not be changed by the nonlinear effect, thus allowing the AEC to quickly recover when the non-linear effect or effects terminate.

As previously noted, clipping and audio glitches are two typical non-linear effects that can have an enormous impact on the echo cancellation quality. Fortunately, both clipping and glitches can be detected quickly before they corrupt the adaptive filter. When signal clipping or a glitch is detected, the adaptive filter stops adaptation for the duration of the event.

When a glitch occurs, some data samples are lost during the speaker rendering or microphone capturing process. As a result, the microphone signal or speaker signal received by the AEC is not continuous. Accordingly, a glitch can be detected by examining the timestamps of the data frames sent to AEC. The timestamps denote the time when a data frame is rendered or captured at the audio device. When the timestamps of two consecutive data frames are not continuous, glitch is detected. Clipping, on the other hand, can be readily detected by saturation of data samples. That is, when an audio signal reaches its maximum (or minimum negative) value, clipping is detected.

Usually input signal clippings and audio glitches have a relatively short duration. While the quality of the echo cancellation during this period may be poor, its impact is limited if the AEC adaptation is disabled during this period so that the AEC can recover quickly. However, some non-linear effects cannot be detected quickly, some may last for a long time, and some may happen repeatedly. Examples of such non-linear effects include sudden changes in microphone or speaker gain and a high rate of drift between the capture and render audio streams. In such cases, the poor quality of the echo cancellation may last for a long time and could significantly interfere with the user experience. In these situations mitigation of the problem by the temporary suspension of the adaptive filter adaptation process may not be sufficient.

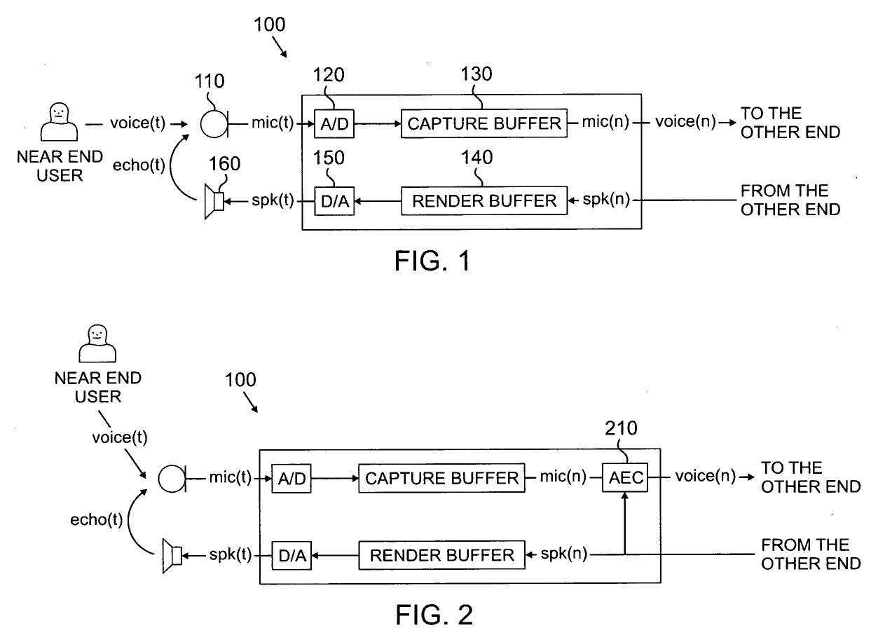

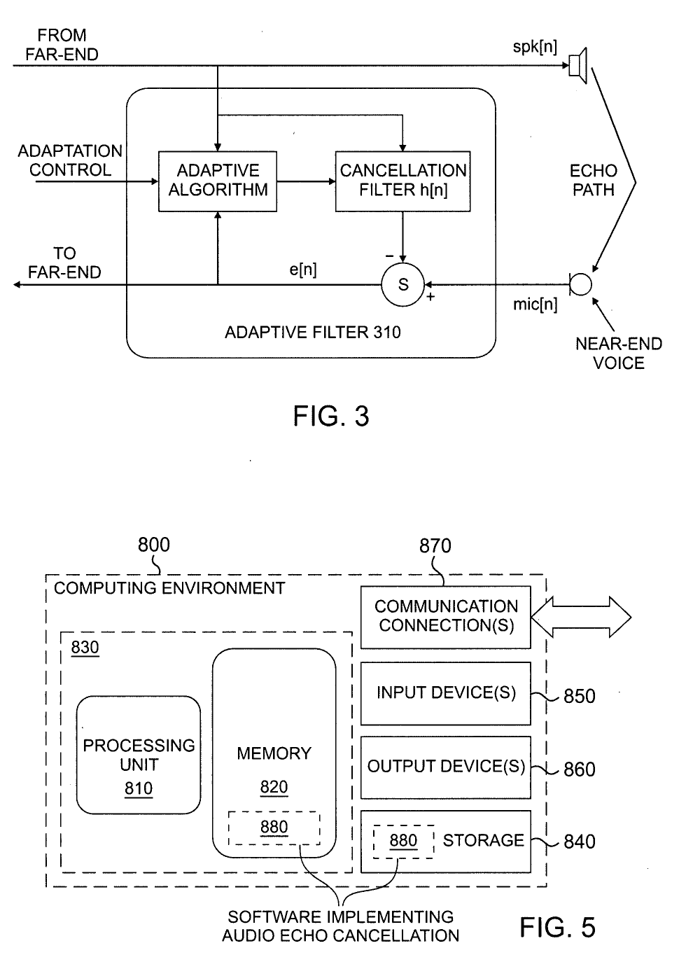

In those cases when non-linear effects may last for an unduly long time (e.g., long enough for the users to decide that it is difficult to conduct a normal two-way conversation), it may be necessary to resolve the problem, by, for example, switching from full-duplex communication to half-duplex communication. In full-duplex communication, both the transmit and receive channels (i.e., the capture and render stream paths in FIGS. 1 and 2) are active at the same time. In half-duplex communication, only one channel is active at any given time, i.e., if the transmit channel is active, then the receive channel is inactive, and visa versa.

When half-duplex communication is implemented, the echo path is broken and thus echoes are effectively eliminated. If both the local and remote users talk at the same time, the voice signals attempting to traverse the inactive channel will be lost. Although half-duplex communication does not allow both users to talk simultaneously, this will often be a better alternative than having the users hear their own echoes. Furthermore, the adaptive filter may still be running, and the ERLE engine and the non-linear effect detector may also be running to monitor the AEC quality when half-duplex communication is implemented. Accordingly, when the non-linear effect is no longer present and the AEC quality recovers to a normal level, communication can return to a full-duplex mode of operation and the AEC will once again begin to remove echoes.

When the system is operating in half-duplex mode an algorithm is employed to determine which of the two channels will be active any given time. The algorithm may employ any suitable criteria in selecting the active channel. For example, in some cases the channel carrying the louder of the two voices will be selected as the active channel and the channel carrying the softer of the two voices will be selected as the inactive channel. Switching the channels between an active and inactive mode in this manner is often referred to as voice switching.

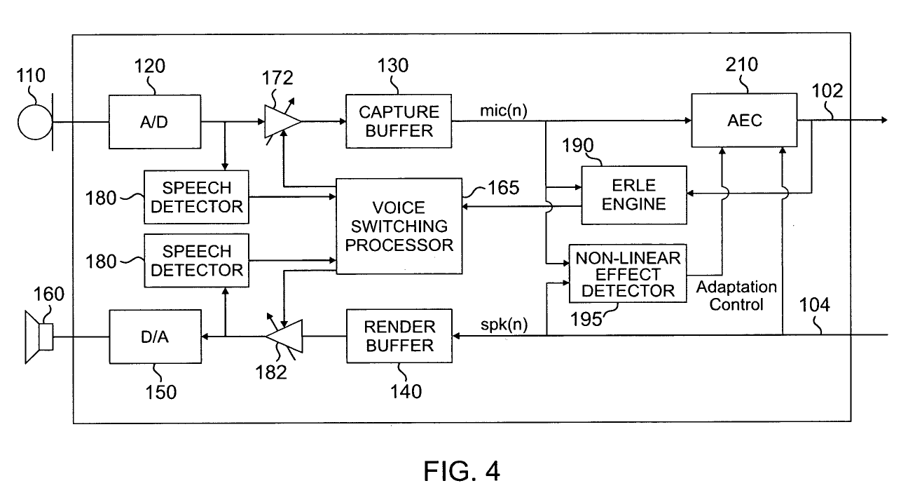

FIG. 4 shows one end of a two-way communication system 300 in which a non-linear effect detector is employed to detect non-linear effects and temporarily disable adaptation of the adaptive filter. The communication system 300 also employs voice switching when a nonlinear effect interferes with the quality of communication for a duration that extends beyond that normally associated with non-linear effects. The system 300 includes a capture or transmit channel 102 and a render or receive channel 104. The capture or transmit channel 102 includes, in the downstream direction, microphone 110 for capturing analog sound, an analog to digital (A/D) converter 120 to convert the analog sound captured by microphone 110 to digital audio samples, a transmit switcher 172 for adding attenuation into transmit channel 102, capture buffer 130 for saving the digital audio sample, an AEC 210 for retrieving the digital audio samples from the capture buffer 130 and removing the predicted echo before transmitting the audio samples to the remote end. Likewise, the render or receive channel 104 includes, in the upstream direction, a render buffer 140 for receiving digital audio samples from the remote end, a receive switcher 182 for adding attenuation into the receive channel 104, a digital to analog (D/A) converter 150 for reading the audio samples from the render buffer 140 and converting them to an analog signal for rendering by speaker 160.

System 300 also includes a non-linear effect detector 195, which monitors the input microphone, speaker signals and timestamps. When a clipping or an audio glitch is detected, the detector directs the adaptive filter to stop adaptation for the duration of the non-linear effect plus a predetermined extra duration.

System 300 also includes a voice switching processor 165 and speech detectors 170 and 180. The speech detector 170 measures the instantaneous speech level on the transmit channel 102. The speech detector 180 measures the instantaneous speech level on the receive channel 104. The two speech detectors 170 and 180 pass their respective instantaneous speech level measurements to the voice switching processor 165.

The voice switching processor 165 continuously monitors the speech detector levels and, in some embodiments, selects the channel having the larger speech level as the active channel. If the transmit channel 102 is active, then the transmit switcher 182 is set to a minimum attenuation, typically 0 dB, and the receiver switcher 172 is set to a high attenuation, typically 40 dB. The minimum attenuation may be referred to as the “Switch ON” and the high attenuation may be referred to as the “Switch OFF”. Similarly, if the receiver channel 104 is the active channel, then the transmit switch 172 is set to the Switch OFF, and the receiver switch 182 is set to the Switch ON. When the active channel is changed from one channel to the other, the switcher attenuation of the previously inactive channel is decreased from the Switch OFF until it is reaches the Switch ON, while at the same time, the switcher attenuation of the previously active channel is increased from the Switch ON to the Switch OFF. This switch in the active channel from one channel to the other is controlled by the voice switching processor 165, and is done over a finite period of time, typically in the range of 10's of milliseconds so as to avoid audible clicks being produced.

System 300 needs to determine when to switch between a half-duplex mode and a full-duplex mode. That is, the system 300 needs to determine when a nonlinear effect sufficiently interferes with the quality of communication for a long duration such that users perceive it is difficult to conduct a normal conversation. The determination can be based on any quality metrics that can accurately reflect the current operational state of the echo canceller. In the particular example depicted in FIG. 4, system 300 includes an Echo Return Loss Enhancement (ERLE) engine 190 for this purpose. The ERLE metric is a ratio measuring the attenuation of the echo in relation to the error. That is, ERLE describes the amount of energy removed from the microphone signal by the AEC 210. This is the amount of loss the adaptive filter provides in the speaker-room-microphone path before transmitting the signal to the remote end point. ERLE can be defined as 10*log[e(n)/y(n)], where e(n) is the energy of the audio signal after cancellation and y(n) is the energy of the input microphone audio signal. Accordingly, in FIG. 4, the ERLE receives samples of the digital voice signal from the transmission path at points before the A/D converter 120 and after the AEC 110.

When the ERLE engine 190 measures an ERLE that is sufficiently high, indicating that echo is being adequately removed by the AEC, the ERLE engine 190 sends a signal to the voice switching processor 165 directing it to maintain the system in full-duplex mode. On the other hand, when the ERLE engine measures an ERLE that is relatively low, indicating that the echo is not being adequately removed by the AEC (generally because of a non-linear effect), the ERLE engine sends a signal to the voice switching processor 165 directing it to switch to a half-duplex mode of operation. When the system is in the half-duplex mode, AEC is still running in the background, and the ERLE is still being measured. When the ERLE engine detects that the ERLE has recovered to a normal level, it sends a signal to voice switching processor 165 directing it to switch back to the full-duplex mode of operation. The definition of what constitutes a high/low ERLE may be derived by experimentation, statistical modeling, or any other appropriate means.

The ERLE as defined above is generally calculated for each data frame in the audio signal. The ERLE as defined in this manner can have a high variance from one frame to another and thus may not provide an accurate estimate of the AEC's current status. Accordingly, in some cases it may be advantageous to use instead of the ERLE, a value of the ERLE that is averaged over a short period of time or over a relatively few number of frames. Such an averaged value of the ERLE can be referred to as the short-term averaged ERLE.

### Computing Environment

The above-described robust, high quality AEC digital signal processing techniques can be realized on any of a variety of two-way communication systems, including among other examples, computers; speaker telephones; two-way radio; game consoles; conferencing equipment; and etc. The AEC digital signal processing techniques can be implemented in hardware circuitry, in firmware controlling audio digital signal processing hardware, as well as in communication software executing within a computer or other computing environment, such as shown in FIG. 5.

FIG. 5 illustrates a generalized example of a suitable computing environment 800 in which described embodiments may be implemented. The computing environment 800 is not intended to suggest any limitation as to scope of use or functionality of the invention, as the present invention may be implemented in diverse general-purpose or special-purpose computing environments.

With reference to FIG. 5, the computing environment 800 includes at least one processing unit 810 and memory 820. In FIG. 5, this most basic configuration 830 is included within a dashed line. The processing unit 810 executes computer-executable instructions and may be a real or a virtual processor. In a multi-processing system, multiple processing units execute computer-executable instructions to increase processing power. The memory 820 may be volatile memory (e.g., registers, cache, RAM), non-volatile memory (e.g., ROM, EEPROM, flash memory, etc.), or some combination of the two. The memory 820 stores software 880 implementing the described audio digital signal processing for robust and high quality AEC.

A computing environment may have additional features. For example, the computing environment 800 includes storage 840, one or more input devices 850), one or more output devices 860, and one or more communication connections 870. An interconnection mechanism (not shown) such as a bus, controller, or network interconnects the components of the computing environment 800. Typically, operating system software (not shown) provides an operating environment for other software executing in the computing environment 800, and coordinates activities of the components of the computing environment 800.

The storage 840 may be removable or non-removable, and includes magnetic disks, magnetic tapes or cassettes, CD-ROMs, CD-RWs, DVDs, or any other medium which can be used to store information and which can be accessed within the computing environment 800. The storage 840 stores instructions for the software 880 implementing the described audio digital signal processing for robust and high quality AEC.

The input device(s) 850 may be a touch input device such as a keyboard, mouse, pen, or trackball, a voice input device, a scanning device, or another device that provides input to the computing environment 800. For audio, the input device(s) 850 may be a sound card or similar device that accepts audio input in analog or digital form, or a CD-ROM reader that provides audio samples to the computing environment. The output device(s) 860 may be a display, printer, speaker, CD-writer, or another device that provides output from the computing environment 800.

The communication connection(s) 870 enable communication over a communication medium to another computing entity. The communication medium conveys information such as computer-executable instructions, compressed audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The described audio digital signal processing for robust and high quality AEC techniques herein can be described in the general context of computer-readable media. Computer-readable media are any available media that can be accessed within a computing environment. By way of example, and not limitation, with the computing environment 800, computer-readable media include memory 820, storage 840, communication media, and combinations of any of the above.

The described audio digital signal processing for robust and high quality AEC techniques herein can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment.

For the sake of presentation, the detailed description uses terms like “determine,” “generate,” “adjust,” and “apply” to describe computer operations in a computing environment. These terms are high-level abstractions for operations performed by a computer, and should not be confused with acts performed by a human being. The actual computer operations corresponding to these terms vary depending on implementation.

In view of the many possible embodiments to which the principles of our invention may be applied, we claim as our invention all such embodiments as may come within the scope and spirit of the following claims and equivalents thereto.

We claim:

1. A method for reducing adverse impact of echo on audio quality in a two-communication system, comprising:
monitoring a parameter reflecting signal quality;
switching between a full-duplex mode of operation and a half-duplex mode of operation based on the signal quality parameter; and
adaptively filtering an echo-containing audio signal when in the full duplex mode of operation.

2. The method of claim 1 further comprising:
detecting audio signal clipping and/or an audio glitch; and
disabling filter adaptation for at least a duration of the audio signal clipping and/or the audio glitch.

3. The method of claim 1 wherein filter adaptation is disabled for the duration of the non-linear effect plus a predetermined extra duration.

4. The method of claim 1 wherein switching the mode of operation from the full-duplex to the half-duplex mode of operation is only performed when the signal quality parameter falls below a given value for a predetermined period of time.

5. The method of claim 1 wherein switching the mode of operation back to the full-duplex from the half-duplex mode of operation is only performed when the signal quality parameter rises above a given value for a predetermined period of time.

6. The method of claim 1 further comprising voice switching between transmit and receive channels when in the half-duplex mode of operation.

7. The method of claim 1 wherein the parameter reflecting signal quality is ERLE.

8. The method of claim 1 wherein the parameter reflecting signal quality is short-term averaged ERLE.

9. A method for reducing adverse impact of echo on audio quality in a two-communication system, comprising:
adaptively filtering an echo-containing audio signal; and
disabling filter adaptation temporarily when a non-linear effect is detected; and
switching from a full-duplex mode of operation to a half-duplex mode of operation if a signal quality parameter falls below a given value; and
switching back to the full-duplex mode of operation from the half-duplex mode of operation if the signal quality parameter rises above the given value.

10. The method of claim 9 wherein the non-linear effect is a glitch in or clipping of the audio signal.

11. The method of claim 9 further comprising voice switching between transmit and receive channels when in the half-duplex mode of operation.

12. The method of claim 9 wherein the signal quality parameter is ERLE.

13. The method of claim 9 wherein the signal quality parameter is short-term averaged ERLE.

14. A communications end device of a two-way communications system, comprising:
an audio signal capture device for capturing local audio to be transmitted to another end device along a transmit path;
an audio signal rendering device for playing remote audio received from the other end device along a receive path;
an audio echo canceller operating to predict echo from the rendered audio signal and to subtract the predicted echo from the local audio transmitted to the other end device;
a signal quality engine for monitoring a parameter reflecting signal quality in the local audio after subtracting the predicted echo;
a switching arrangement for switching from a full-duplex mode of operation on both the transmit and receive paths to a half-duplex mode of operation if the signal quality parameter falls below a given value; and
for switching back to the full-duplex mode of operation if the signal quality parameter rises above the given value.

15. The communications end device of claim 14 wherein the switching arrangement is configured to switch the mode of operation from the full-duplex mode to the half-duplex mode of operation when the signal quality parameter falls below the given value for a predetermined period of time.

16. The communications end device of claim 14 wherein the switching arrangement is configured to switch the mode of operation back to the full-duplex mode from the half-duplex mode of operation when the signal quality parameter rises above the given value for a predetermined period of time.

17. The communications end device of claim 14 further comprising a speech detector for detecting speech levels on the transmit and receive paths and wherein the switching arrangement is configured to select as an active path the path having a larger speech level when in the half-duplex mode of operation.

18. The communications end device of claim 14 wherein the signal quality parameter is ERLE.

19. The communications end device of claim 14 wherein the signal quality parameter is short-term averaged ERLE.

20. The communications end device of claim 14 further comprising a detector for detecting a glitch in, or clipping of, the local audio before adaptive filter processing.
